(19) United States
(12) Patent Application Publication
(10) Pub. No.: US 2023/0357059 A1
(43) Pub. Date: Nov. 9, 2023

(54) IN CHANNEL MAGNETIC RECOVERY

(71) Applicant: Evoqua Water Technologies LLC, Pittsburgh, PA (US)

(72) Inventor: TIMOTHY LINDEMANN, Oconomowoc, WI (US)

(73) Assignee: Evoqua Water Technologies LLC, Pittsburgh, PA (US)

(21) Appl. No.: 18/026,119

(22) PCT Filed: Sep. 10, 2021
(86) PCT No.: PCT/US21/49821

§ 371 Date: Mar. 13, 2023

Related U.S. Application Data
(60) Provisional application No. 63/076,964, filed on Sep. 11, 2020.

(51) Int. Cl. C02F 1/48; C02F 1/52; C02F 1/28

(52) U.S. Cl. CPC C02F 1/481; C02F 1/488; C02F 1/52; C02F 1/28; C02F 2303/18

(57) ABSTRACT

Systems and methods for water treatment involving use of a magnetic ballast material to facilitate settling operations are provided. Magnetic ballast material is recovered downstream of clarification with a magnetic drum for reuse. At least one in-line magnetic recovery device augments the recovery of magnetic ballast material.

### FIELD OF THE TECHNOLOGY

One or more aspects relate generally to water treatment and, more particularly, to systems and methods for water treatment using ballasted settling.

### BACKGROUND

Ballast material may be used to enhance clarification operations in various water treatment operations to improve effluent water quality.

### SUMMARY

In accordance with one or more aspects, a system for treating water is disclosed. The system may comprise a ballast reactor tank having an inlet to receive water for treatment, a source of magnetic ballast material fluidly connected to the ballast reactor tank, a clarifier fluidly connected downstream of the ballast reactor tank, the clarifier having a treated effluent outlet and a ballasted solids outlet, and a magnetic separation system configured to recover magnetic ballast material downstream of the clarifier and return the recovered magnetic ballast material to the ballast reactor tank. The magnetic separation system may comprise a magnetic drum fluidly connected to the ballasted solids outlet of the clarifier, the magnetic drum having a waste solids outlet, and an in-line magnetic recovery device fluidly connected to at least one of the waste solids outlet of the magnetic drum and the treated effluent outlet of the clarifier.

In some aspects, the magnetic ballast material comprises magnetite. The magnetite may be defined by a particle size of less than about 100 μm. The magnetite may be defined by a particle size of less than about 50 μm, e.g. less than about 20 μm.

In some aspects, the in-line magnetic recovery device may comprise an array of rotating magnetic discs. The magnetic separation system may further comprise a scraper assembly associated with the array of rotating magnetic discs. The array of rotating magnetic discs may be integrated with a rotating disc filter.

In some aspects, the in-line magnetic recovery device may comprise an array of magnets mounted on a conveyor belt.

In some aspects, the in-line magnetic recovery device may comprise an array of magnetized tubes. The array of magnetized tubes may be arranged substantially vertically in a process channel. The array of magnetized tubes may be positioned slanted in a process channel.

In some aspects, the magnetic separation system may comprise a first in-line magnetic recovery device fluidly connected to the waste solids outlet of the magnetic drum and a second in-line magnetic recovery device fluidly connected to the treated effluent outlet of the clarifier.

In some aspects, the magnetic separation system may further comprise a mechanical shearing unit operation upstream of the magnetic drum.

In some aspects, the system may further comprise a source of at least one of a flocculant, a coagulant and an adsorbent fluidly connected to the ballast reactor tank.

In some aspects, the magnetic separation system may be configured to recover at least about 96% to about 98% of the magnetic ballast material downstream of the clarifier.

In accordance with one or more aspects, a method for treating water is disclosed. The method may comprise introducing a source of water to a ballast reactor tank for treatment, adding a magnetic ballast material to the ballast reactor tank to provide a ballasted effluent, separating the ballasted effluent into treated effluent and ballasted solids, introducing the ballasted solids to a magnetic drum to provide waste solids, introducing at least one of the waste solids and the treated effluent to an in-line magnetic recovery device, and returning recovered magnetic ballast material from both the magnetic drum and the in-line magnetic recovery device to the ballast reactor tank.

In some aspects, both the waste solids and the treated effluent may be introduced to in-line magnetic recovery devices.

In some aspects, the method may further comprise adding at least one of a flocculant, a coagulant and an adsorbent to the ballast reactor tank.

In some aspects, no cleaning solution is used for ballast recovery.

In accordance with one or more aspects, a method for retrofitting a water treatment system comprising a magnetic ballast reactor tank, a clarifier and a magnetic separation system including a magnetic drum is disclosed. The method may comprise augmenting the magnetic separation system with an in-line magnetic recovery device.

### BRIEF DESCRIPTION OF THE DRAWINGS

The accompanying drawings are not intended to be drawn to scale. For purposes of clarity, not every component may be labeled in the drawings, nor is every component of each embodiment of the disclosure shown where illustration is not necessary to allow those of ordinary skill in the art to understand the disclosure.

In the drawings:

FIGS. 1A and 1B present schematics of water treatment systems incorporating an in-line magnetic recovery device in accordance with various embodiments;

FIGS. 2A-4B present schematics of in-line magnetic recovery devices in accordance with various embodiments; and

FIG. 5 presents modeling data discussed in an accompanying Example.

### DETAILED DESCRIPTION

In accordance with one or more embodiments, systems and methods are provided for treating water. Various unit operations for water treatment may be implemented and clarification involving a ballasted settling process may be incorporated. In some embodiments, a magnetic ballast material may be used and recovered for reuse. A magnetic drum may recover a significant portion of the magnetic ballast material. Beneficially, the magnetic drum may be augmented in accordance with one or more embodiments with at least one in-line magnetic recovery device as described herein to scavenge for additional magnetic ballast material.

In accordance with one or more embodiments, a water treatment system may include various unit operations known to those of ordinary skill in the art. Local, state and/or federal water quality requirements may generally inform the overall composition of a water treatment process. Water may optionally be pretreated, for example, with screening, straining and/or chemical addition. One or more settling or clarification stages may then be implemented. Primary and secondary clarifiers may be used and an intermediate aeration basin may facilitate biological treatment via an activated sludge process. A fixed film biological system or attached growth system may also be used. Water may be further subjected to tertiary treatment which may generally involve filtration or other separation operation to remove any remaining suspended solids or contaminants. Treated water may then optionally be disinfected prior to being stored or delivered for end use.

In accordance with one or more embodiments, various unit operations may incorporate a ballast material to generally facilitate separation. A water treatment system may include a ballast reactor tank configured to provide a ballasted effluent and a source of ballast material fluidly connected to the ballast reactor tank. The addition of ballast, and optionally additional components such as flocculent, coagulant, and/or adsorbent improves the removal of dissolved, colloidal, particulate and microbiological solids. The precipitation and enhanced settleability of ballasted solids provide for a more efficient, for example, smaller and or faster, clarification step as compared to conventional clarification systems, which may allow for a smaller footprint system comprising biological and clarification steps.

In some embodiments, a ballasted system may further include a source of coagulant fluidly connected to a ballast reactor tank. In some embodiments, a ballasted system may further include a source of flocculent fluidly connected to the ballast reactor tank. In some embodiments, a ballasted system may further include a source of adsorbent fluidly connected to the ballast reactor tank.

Flocculation may be a process of contact and adhesion whereby particles and colloids in liquid such as a water or wastewater form larger-size clusters of material. Particles may cluster together in a floc. A flocculent may comprise a material or a chemical that promotes flocculation by causing colloids and particles or other suspended particles in liquids to aggregate, forming a floc. Polymers may be used as flocculants. For example, acrylic acid/acrylamide copolymers and modified polyacrylamides may be used.

Coagulation may be a process of consolidating particles, such as colloidal solids. Coagulants may include cations. They may include cations such as aluminum, iron, calcium, or magnesium (positively charged molecules) that may interact with negatively charged particles and molecules that reduce the barriers to aggregation. Examples of coagulants include bentonite clay, polyaluminum chloride, polyaluminum hydroxychloride, aluminum chloride, aluminum chlorohydrate, aluminum sulfate, ferric chloride, ferric sulfate, and ferrous sulfate monohydrate.

Adsorption may be a physical and chemical process of accumulating a substance at the interface between liquid and solids phases. The adsorbent may be powdered activated carbon (PAC). PAC is an effective adsorbent because it is a highly porous material and provides a large surface area to which contaminants may adsorb. PAC may have a diameter of less than 0.1 mm and an apparent density ranging between about 20 and about 50 lbs./ft³. PAC may have a minimum iodine number of 500 as specified by AWWA (American Water Works Association) standards.

Ballasted systems may generally involve the addition of a ballast, and optionally, a coagulant and/or flocculent to improve the removal of dissolved, colloidal, particulate, and microbiological solids. The enhanced settleability of these ballasted solids may provide for a small clarification step, which may allow for a small footprint system comprising biological and clarification steps. In some, but not all, embodiments, recirculation of solids, either ballasted solids or ballast-free solids, to at least one of the ballasted processes, such as the ballast mixing step and/or to a biological reactor or process can further enhance the reliability of the overall system.

In accordance with one or more embodiments, a source of ballast may be fluidly connected to a reactor tank to provide a ballasted effluent. In some embodiments, the source of ballast may be fluidly connected to a coagulated effluent. The source of ballast may comprise a powdered ballast. The ballast may not be in a liquid such that it may be added in dry powdered form. In some embodiments, the ballast may be added by an operator or by machinery, such as by a dry feeder. It is to be understood that the source of ballast being fluidly connected, for example, to a biological reactor effluent or a coagulated effluent or to any effluent or process stream of the system may be in a dry (non-liquid) or powdered form. A clarifier may be fluidly connected to the ballasted effluent, the clarifier comprising a treated effluent outlet and a ballasted solids outlet and configured to separate a treated effluent from a ballasted solids portion. The ballasted solids outlet of the clarifier may be fluidly connected to at least one of a coagulated effluent and the ballast reactor tank. In some embodiments, the ballasted solids outlet may be fluidly connected to the source of ballast.

A source of flocculent may be fluidly connected to the ballast reactor. At least one of the sources of coagulant, ballast, flocculent, and adsorbent may be provided in line to a biological reactor effluent stream. Alternately, tanks may be used such that the biological reactor effluent flows to a coagulant tank, into which a coagulant is added from a source of coagulant. The coagulated effluent may then flow to a ballast tank, into which a ballast is added from a source of ballast. The ballasted effluent may then flow to a flocculent tank, into which a flocculent is added from a source of flocculent. The flocculent effluent may then flow to the clarifier. In certain embodiments, a flocculent tank and source of flocculent may not be included in the ballasted flocculation system, and the ballasted effluent may flow directly to the clarifier. In some embodiments, a coagulant tank and source of coagulant may not be included in the ballasted flocculation system.

In accordance with one or more embodiments, the ballast material may be a magnetic ballast material. The magnetic ballast may comprise an inert material. The magnetic ballast may comprise a ferromagnetic material. The magnetic ballast may comprise iron-containing material. In certain embodiments, the magnetic ballast may comprise an iron oxide material.

For example, the magnetic ballast may comprise magnetite (Fe₃O₄). The magnetic ballast may have a particle size that allows it to bind with biological and chemical flocs to provide enhanced settling or clarification, and allow it to be attracted to a magnet so that it may be separated from the biological flocs. The particle size of the ballast, for example, the magnetic ballast, may be less than about 100 μm. In some embodiments, the particle size of the ballast, for example, the magnetic ballast, may be less than about 40 μm. In an embodiment, the particle size of the ballast, for example, the magnetic ballast may be less than about 20 m. For example, the particle size may be between about 80 to about 100 μm, about 60 μm to about 80 μm, about 40 μm to about 60 μm, about 20 μm to about 40 μm, or about 1 μm to about 20 μm.

Sand ballasted systems often implement larger ballast sizes to effectively recover the ballast. Sand ballast is non-magnetic. Sand ballasted systems have implemented the use of cleaning agents to separate the biological solids from the sand particles. This could be a result of a large surface for bacteria to attach, requiring more than shearing forces of a vortex mechanism alone to remove biological solids from the sand particle surface, or the need to dissolve chemical bonds that assist in the binding of the ballast.

Unlike sand-based ballast that requires growth of floc around relatively large size sand particles, magnetite ballast can be used with small size, such as less than about 100 μm, allowing for the magnetite particles to impregnate existing floc. The result may be an enhanced separation of flocculants. The ballasted effluent or the flocculent effluent may be directed to at least one clarifier where ballasted solids, such as magnetite ballasted solids, may be removed by gravity at an enhanced rate greater than conventional gravity clarifiers. The clarifier, being configured to provide a treated effluent and a ballasted solids portion, may be fluidly connected to at least one of the source of ballast, the coagulated effluent, and the biological reactor. In certain embodiments, the ballasted solids outlet of the clarifier may be fluidly connected to at least one of the coagulated effluent and the ballast reactor tank. This may allow at least a portion of the ballasted solids to return to the ballast reactor tank and to the source of ballast, for example, the ballast tank connected to a source of ballast. All or a portion of the biological solids may also be removed from the system. This may involve utilizing a ballasted recovery system or wasting the biological solids prior to a ballasted recovery system.

In some embodiments, the ballasted recovery system may comprise a magnetic separation apparatus, which may allow recovery of magnetic particles, which would not be feasible with, for example, sand particles. The recovery of the magnetic particles may be positioned, for example, downstream from the clarifier and upstream of the source of magnetite and/or the ballast reactor. In certain embodiments, mechanical shearing may be employed to shear the biological solids prior to ballast recovery, for example, prior to magnetite recovery. In some instances, such as re-seeding and high flow events, a portion of the settled biological solids may be recycled to the front of the ballast reactor tank. These solids may either be ballasted or solids stripped of magnetite through the magnetic separation. In certain embodiments, such as small-scale operations, it may not be necessary or feasible to recover the ballast, such as the magnetic ballast, from the system.

In certain embodiments, a ballasted recovery system may be positioned downstream of the ballasted solids outlet of the clarifier. The ballasted recovery system may be positioned upstream of at least one of the source of ballast and the biological reactor.

In certain embodiments, the use of a magnetic ballast provides advantages over use of other ballast materials. For example, a magnetic drum may be used to separate the biological solids from the magnetic ballast in an efficient manner. Optionally, mechanical shearing may be utilized prior to separation. This process may sufficiently remove the biological solids from the ballast. Recirculation of settled solids to the ballast reaction tank further enhances performance and reliability and allows for additional flexibility for treatability and recovery in process upsets or startups. In certain embodiments, cleaning solutions are unnecessary in separating ballast from the biological solids.

In accordance with one or more embodiments, a magnetic separation system may be configured to recover magnetic ballast material downstream of the clarifier and return the recovered magnetic ballast material to the ballast reactor tank. The magnetic separation system may include a magnetic drum fluidly connected to the ballasted solids outlet of the clarifier. While the magnetic drum may recover at least 95% of the magnetite used in the ballasted system, it may be desirable to further improve the recovery of magnetite, for example, particularly on the process effluent.

In accordance with one or more embodiments, it is possible to recover and reuse remaining magnetite found in the effluent water and/or the waste solids of the magnetic drum. In some embodiments, the system may be configured to recover at least about 96% to about 98% of the magnetic ballast material downstream of the clarifier. Beneficially, additional contaminate removal may also result assuming the magnetic ballast material is bound with organics.

In accordance with one or more embodiments, the magnetic separation system may further include at least one in-line magnetic recovery device to serve as a polisher or scavenger for additional magnetite recovery. The in-line magnetic recovery devices may generally be constructed and arranged in process flow channels to collect remnant magnetite. These in-line or in-channel magnetic recovery devices may be fluidly connected in order to provide further processing at the waste solids outlet of the magnetic drum and/or the treated effluent of the clarifier.

In accordance with one or more embodiments, an in-channel magnetic recovery system may be used to recover magnetite and can be applied to the effluent flow stream and/or the solids waste stream. The in-line magnetic recovery devices can involve any structure or approach capable of recovering residual magnetite from a process stream. This disclosure should not be limited to any specific potential embodiments which are described herein for example purposes only.

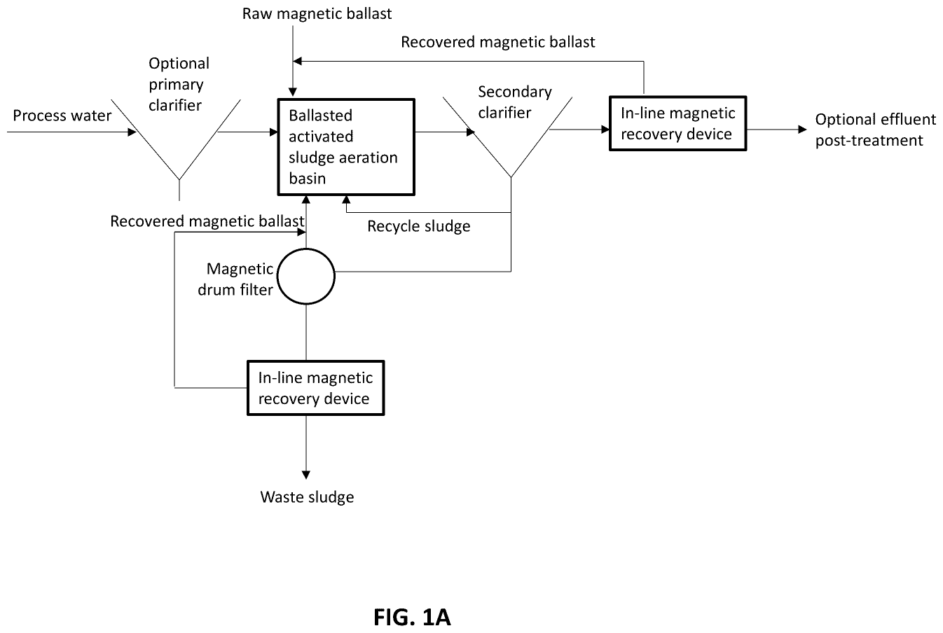

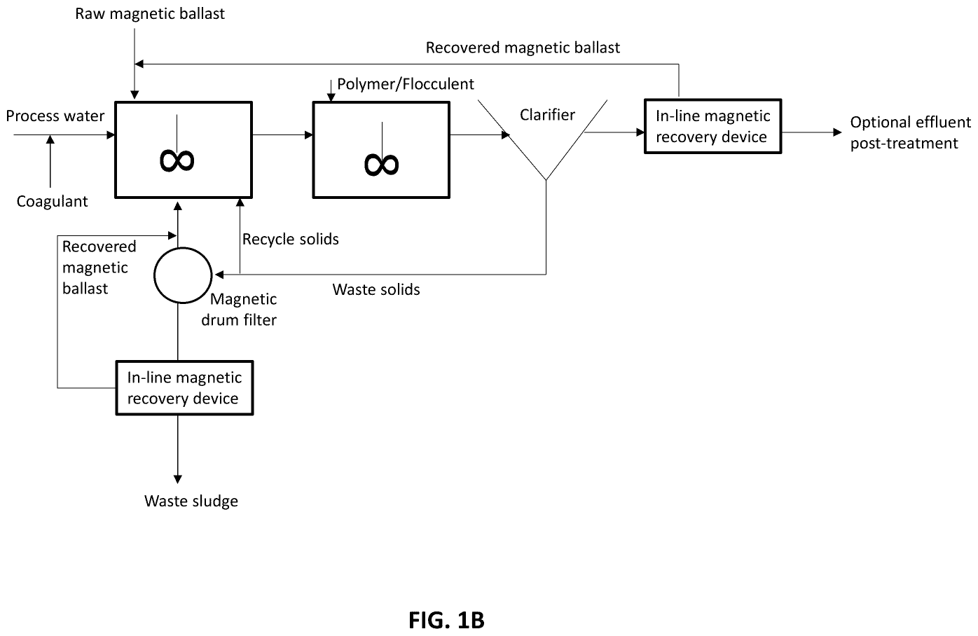

FIG. 1A presents a schematic of a water treatment system involving primary and secondary clarification. Magnetic ballast material is added to the aeration basin. Effluent from the secondary clarifier may be subjected to an in-channel magnetic ballast recovery device. Waste solids from the secondary clarifier may be subjected to a magnetic drum for ballast recovery. The waste sludge from the magnetic drum may be subjected to an in-channel magnetic ballast recovery device to scavenge for remnant magnetic ballast material. Recovered magnetic ballast material may be returned to the aeration basin.

FIG. 1B presents a schematic of a water treatment system in which ballast material, coagulant and flocculent are added to the process water in a staged approach. A downstream clarifier is used for settling. Effluent from the clarifier may be subjected to an in-channel magnetic ballast recovery device. Waste solids from the clarifier may be subjected to a magnetic drum for ballast recovery. The waste sludge from the magnetic drum may be subjected to an in-channel magnetic ballast recovery device to scavenge for remnant magnetic ballast material. Recovered magnetic ballast material may be returned to the reactor(s) according to various techniques commonly apparent to those skilled in the art.

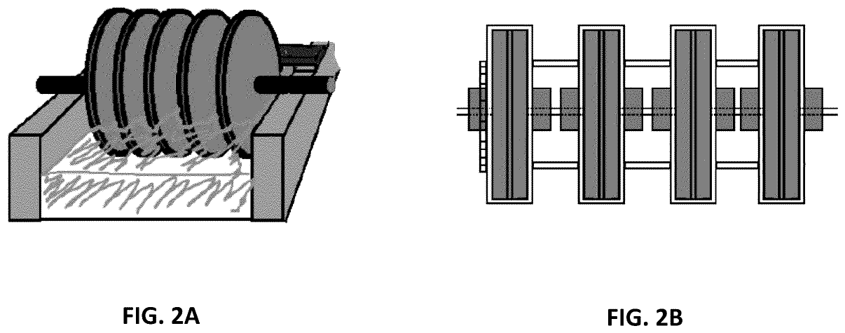

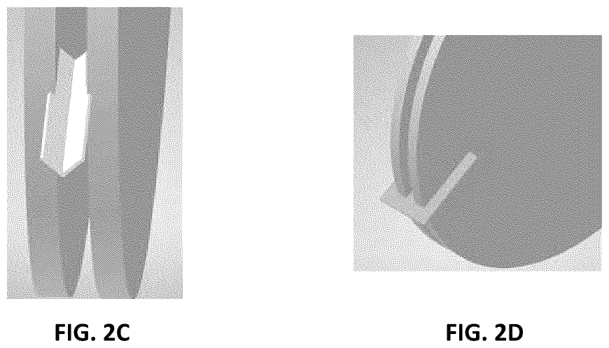

In some non-limiting embodiments, the in-line magnetic recovery device may include a rotating shaft with magnetic disc elements attached thereto that are partially submerged in channel as presented in FIG. 2A. FIG. 2B presents a related cross-sectional view. The discs may rotate and carry magnetic material out of the channel. Various overall design considerations including spacing between discs, number of shafts in series, channel configuration including depth and head losses may be informed by a specific intended application. On the back side, positive means of scraping and/or removal of magnetic solids may be implemented via, for example, pneumatic blowing, a doctor blade, air flow or water flow. Recovered magnetic ballast material may be conveyed into a sluicing channel where it is re-introduced to the main process using magnetic ballast. The discs may rotate with flow or counter current. The discs may be fixed magnets themselves on a rotating shaft, or the discs may include a fixed magnet array and shaft with a rotating shell. Multiple assemblies may have a connecting rod and the entirety may be rotated directly or indirectly, i.e. chain/belt driven. The connecting rods may be made flat and/or otherwise utilize the water's energy in the channel to rotate the assembly.

The rotating discs may convey magnetic material out of the process water which is then in turn removed from the discs. With the fixed magnet array inside the rotating disks, an array may be created such that no scrapers are needed. The magnetic ballast material may build at the point where the magnets stop and slough off into a channel. The channel may have finger weirs protruding from the edge of the disks towards the shaft as far as needed. The array may be lower at the outside of the disk and higher inwards to facilitate sloping the channel to move material away from the disks. Water spray may be used to move the material in the channel and/or spray the material into the channel. FIGS. 2C and 2D present schematics of various potential scrapers. FIG. 2C illustrates a v-style plastic scraper assembly which may be used to scrape and convey magnetic ballast from in-between magnetized discs. FIG. 2D illustrates a square or rectangular scraping blade which may provide interference with respect to the discs. The scraper blade may be made of, for example, rubber or plastic and may be mounted atop a more rigid chute that has no contact with the discs. The magnetic material removed may be discharged to a hopper. A slurry may be made and either directly pumped back to the ballasted process, or the hopper may be fluidly connected to an eductor system to send magnetic ballast material back to the ballasted process.

In accordance with one or more embodiments, the magnetic discs may be integrated or otherwise combined with a rotating disc filter with magnetic discs added. The conventional disc filter may capture various solids. The addition of magnetic discs may allow for higher solids loading as the magnetic discs divert and capture magnetic solids away from the filter elements.

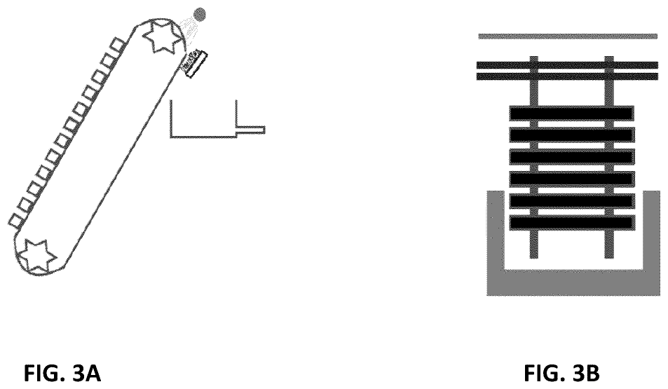

In some non-limiting embodiments, the in-line magnetic recovery device may include a fixed array of magnets mounted on a conveyor as illustrated in FIG. 3A. FIG. 3B provides a related perspective view. This in-channel magnetics recovery design may generally involve a conveyor belt with sleeves of fixed magnets arrays attached. The magnets may be spaced apart based on an intended application and the conveyor speed may be optimized based on various operational parameters such as flow rate. Magnetic material in channel may become attached to the magnets. The magnets are moved out of the process and washed off via positive means, such as brush and water. The recovered magnetic material may be discharged to a hopper. A slurry may be made and either directly pumped, or the hopper may be connected to a water system and an eductor may be used to convey the magnetic material back to the ballasted process.

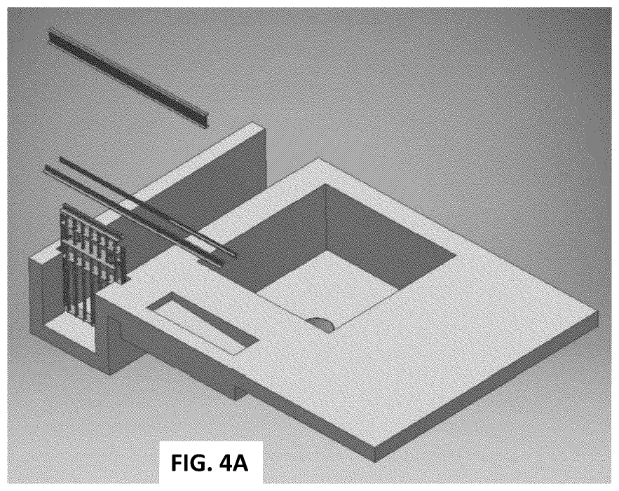

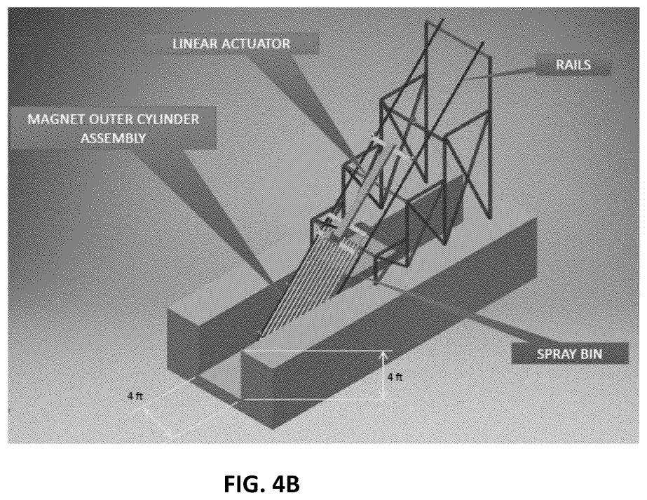

In some non-limiting embodiments, the in-line magnetic recovery device may include a series of magnetized tubes to capture remnant magnetic ballast material. Tube size, spacing, orientation and other design parameters may be optimized based on an intended application. Washing and material return may generally be more complex in these embodiments as the tubes may be raised and wiped/washed above the channel. Wiper design, water pressure and washing, angle of lift and other parameters may be significant design considerations to effectively remove ballast material from the channel and then wash it off where it can be returned. FIG. 4A presents an embodiment involving an array of vertically aligned magnetized tubes and FIG. 4B presents an embodiment involving an array of slanted magnetized tubes. Fixed magnets may be arranged in the array of tubes or the tubes may otherwise be magnetized. Magnetic sleeves may be arranged in outer cylinders. The array of tubes may trap magnetic ballast material in the process channel. The array of tubes may then be at least partially removed from the channel to release the captured magnetic ballast material for recycle. For example, a conveyor system may move the plurality of tubes for removal of magnetic ballast material. In various non-limiting embodiment, a linear actuator may move the array of magnetized tubes along rails. A winch may lift the assembly up to the rails. The captured magnetic ballast material may be scraped, sprayed, washed or blow off into a sluicing channel and distributed to the main ballasted process.

In accordance with one or more embodiments, an in-line magnetic recovery device as described herein or otherwise may be positioned in any channel where process flow may contain remnant magnetic ballast material. In waste channels, magnetic solids may be removed before wasting solids from the facility with the intention being to separate magnetic solids from the non-magnetic solids. In effluent channels, the intent may generally be to capture magnetic solids and also capture non-magnetic solids that are incorporated with the magnetic solids for an overall solids reduction prior to discharge or further processing. In accordance with one or more embodiments, the magnetic separation system may include an in-line magnetic recovery device fluidly connected to the waste solids outlet of the magnetic drum. In accordance with one or more other embodiments, the magnetic separation system may include an in-line magnetic recovery device fluidly connected to the treated effluent outlet of the clarifier. In accordance with one or more further embodiments, the magnetic separation system may include a first in-line magnetic recovery device fluidly connected to the waste solids outlet of the magnetic drum and a second in-line magnetic recovery device fluidly connected to the treated effluent outlet of the clarifier.

In accordance with one or more embodiments, a method of retrofitting a wastewater treatment system may be provided. A water treatment system may include a magnetic ballast reactor tank, a clarifier and a magnetic separation system including a magnetic drum. The magnetic separation system may be augmented with at least one in-line magnetic recovery device as described herein. In-line magnetic recovery device may be fluidly connected to at least one of the waste solids outlet of the magnetic drum and the treated effluent outlet of the clarifier.

The function and advantage of these and other embodiments of the systems and techniques disclosed herein will be more fully understood from the examples below. The following examples are intended to illustrate the benefits of the disclosed treatment approach, but do not exemplify the full scope thereof.

### EXAMPLE

Batch bench testing was conducted to determine the efficiency of an in-line magnetic ballast recovery system including rotating discs in accordance with one or more disclosed embodiments. Magnetite was mixed with water and doses of 5 and 10 mg/L were tested. Magnetite was picked up by the rotating discs and then scraped from the rotating discs. About 96-98% recovery was achieved with final magnetite levels of about 0.1 to 0.2 mg/L.

### PROPHETIC EXAMPLE

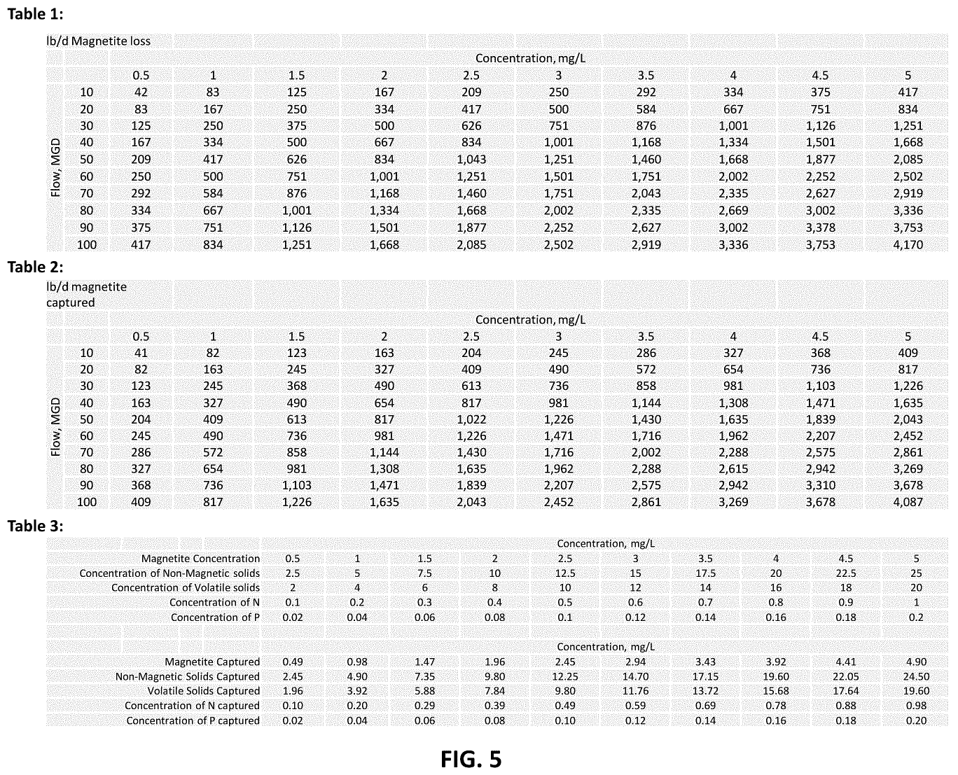

A sensitivity analysis of in-line magnetite recovery from clarifier effluent in a water treatment system in accordance with one or more disclosed embodiments was modeled across a range of dosed concentrations (0.5 mg/L to 5 mg/L) and across a range of process water flow rates (10 MGD to 100 MGD). A ratio of magnetite to TSS of 20% was assumed. VSS % of non-magnetic TSS was assumed to be 80%. A volatile solids (C:N:P ratio) of 100:5:1 was assumed. The modeling data is presented in FIG. 5. Table 1 presents magnetite loss (lb/d) and Table 2 presents magnetite captured (lb/d). Table 3 summarizes the results. 98% magnetite recovery was achievable. Other potential contaminate removal numbers were modeled assuming that the magnetite would be bound with organics. Non-magnetic solids, volatile solids, nitrogen and phosphorous were also captured. Assuming a magnetite cost of $0.25/lb, it is apparent that significant cost savings are achievable by capturing the additional magnetite via scavenging with an in-line magnetic recovery system as disclosed herein.

While exemplary embodiments of the disclosure have been disclosed, many modifications, additions, and deletions may be made therein without departing from the spirit and scope of the disclosure and its equivalents, as set forth in the following claims.

Those skilled in the art would readily appreciate that the various configurations described herein are meant to be exemplary and that actual configurations will depend upon the specific application for which the systems and methods of the present disclosure are used. Those skilled in the art will recognize, or be able to ascertain using no more than routine experimentation, many equivalents to the specific embodiments described herein. For example, those skilled in the art may recognize that the systems, and components thereof, according to the present disclosure may further comprise a network of systems or be a component of a water treatment system. It is, therefore, to be understood that the foregoing embodiments are presented by way of example only and that, within the scope of the appended claims and equivalents thereto, the disclosed system and methods may be practiced otherwise than as specifically described. The present systems and methods are directed to each individual feature or method described herein. In addition, any combination of two or more such features, apparatus or methods, if such features, system or methods are not mutually inconsistent, is included within the scope of the present disclosure.

Further, it is to be appreciated various alterations, modifications, and improvements will readily occur to those skilled in the art. Such alterations, modifications, and improvements are intended to be part of this disclosure, and are intended to be within the spirit and scope of the disclosure. For example, an existing facility may be modified to utilize or incorporate any one or more aspects of the disclosure. Thus, in some cases, the apparatus and methods may involve connecting or configuring an existing facility to comprise an in-line magnetic recovery device. Accordingly, the foregoing description and drawings are by way of example only. Further, the depictions in the drawings do not limit the disclosures to the particularly illustrated representations.

As used herein, the term “plurality” refers to two or more items or components. The terms “comprising, ” “including, ” “carrying, ” “having, ” “containing, ” and “involving, ” whether in the written description or the claims and the like, are open-ended terms, i.e., to mean “including but not limited to. ” Thus, the use of such terms is meant to encompass the items listed thereafter, and equivalents thereof, as well as additional items. Only the transitional phrases “consisting of” and “consisting essentially of, ” are closed or semi-closed transitional phrases, respectively, with respect to the claims. Use of ordinal terms such as “first, ” “second, ” “third, ” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A system for treating water, comprising:
a ballast reactor tank having an inlet to receive water for treatment;
a source of magnetic ballast material fluidly connected to the ballast reactor tank;
a clarifier fluidly connected downstream of the ballast reactor tank, the clarifier having a treated effluent outlet and a ballasted solids outlet; and
a magnetic separation system configured to recover magnetic ballast material downstream of the clarifier and return the recovered magnetic ballast material to the ballast reactor tank, the magnetic separation system comprising:
a magnetic drum fluidly connected to the ballasted solids outlet of the clarifier, the magnetic drum having a waste solids outlet; and
an in-line magnetic recovery device fluidly connected to at least one of the waste solids outlet of the magnetic drum and the treated effluent outlet of the clarifier.

2. The system of claim 1, wherein the magnetic ballast material comprises magnetite.

3. The system of claim 2, wherein the magnetite is defined by a particle size of less than about 100 μm.

4. The system of claim 3, wherein the magnetite is defined by a particle size of less than about 50 μm, e.g. less than about 20 μm.

5. The system of claim 1, wherein the in-line magnetic recovery device comprises an array of rotating magnetic discs.

6. The system of claim 5, wherein the magnetic separation system further comprises a scraper assembly associated with the array of rotating magnetic discs.

7. The system of claim 5, wherein the array of rotating magnetic discs is integrated with a rotating disc filter.

8. The system of claim 1, wherein the in-line magnetic recovery device comprises an array of magnets mounted on a conveyor belt.

9. The system of claim 1, wherein the in-line magnetic recovery device comprises an array of magnetized tubes.

10. The system of claim 9, wherein the array of magnetized tubes is arranged substantially vertically in a process channel. 10 15

11. The system of claim 9, wherein the array of magnetized tubes is positioned slanted in a process channel.

12. The system of claim 1, wherein the magnetic separation system comprises a first in-line magnetic recovery device fluidly connected to the waste solids outlet of the magnetic drum and a second in-line magnetic recovery device fluidly connected to the treated effluent outlet of the clarifier.

13. The system of claim 1, wherein the magnetic separation system further comprises a mechanical shearing unit operation upstream of the magnetic drum.

14. The system of claim 1, further comprising a source of at least one of a flocculant, a coagulant and an adsorbent fluidly connected to the ballast reactor tank.

15. The system of claim 1, wherein the magnetic separation system is configured to recover at least about 96% to about 98% of the magnetic ballast material downstream of the clarifier.

16. A method for treating water, comprising:
introducing a source of water to a ballast reactor tank for treatment;
adding a magnetic ballast material to the ballast reactor tank to provide a ballasted effluent;
separating the ballasted effluent into treated effluent and ballasted solids;
introducing the ballasted solids to a magnetic drum to provide waste solids;
introducing at least one of the waste solids and the treated effluent to an in-line magnetic recovery device; and
returning recovered magnetic ballast material from both the magnetic drum and the in-line magnetic recovery device to the ballast reactor tank.

17. The method of claim 16, wherein both the waste solids and the treated effluent are introduced to in-line magnetic recovery devices.

18. The method of claim 16, further comprising adding at least one of a flocculant, a coagulant and an adsorbent to the ballast reactor tank.

19. The method of claim 16, wherein no cleaning solution is used for ballast recovery.

20. A method for retrofitting a water treatment system comprising a magnetic ballast reactor tank, a clarifier and a magnetic separation system including a magnetic drum, the method comprising:
augmenting the magnetic separation system with an in-line magnetic recovery device.
